(19) United States
(12) Patent Application Publication
(10) Pub. No.: US 2009/0139288 A1
(43) Pub. Date: Jun. 4, 2009

(54) Device and method for opening a pin tumbler type of lock

(76) Inventor: Richard Pettey, Manitou Springs, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/315,459

(22) Filed: Dec. 3, 2008

Related U.S. Application Data
(60) Provisional application No. 61/005,352, filed on Dec. 4, 2007.

(51) Int. Cl. E05B 27/00; E05B 19/20

(52) U.S. Cl. 70/378; 81/15.9; 70/394

(57) ABSTRACT

The invention is a device for opening a pin tumbler type of lock, wherein the pin tumbler type of lock has a number of driver pins and a number of key pins, each of the key pins aligned with one of the driver pins. The device has a housing with a key end and a spring end. A spring inside the housing is located at the spring end of the housing. A slide has a first end fitting inside the housing and abutting an end of the spring. A trigger mechanism is attached to the housing and engages the slide. A key holder is attached to a second end of the slide. A bottom cut key is inserted into the key holder.

### RELATED APPLICATIONS

The present invention claims priority on provisional patent application, Ser. No. 61/005,352, filed on Dec. 4, 2007, entitled “Shock a Lock” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Pin tumbler locks are the most common type of locks used on doorways. In an emergency situation, police and fire personnel need to access doorways quickly but they usually do not have the proper key. The time spent breaking or picking the lock can be a matter of life and death. It is possible to bump a lock, but this method does not always work and often damages the lock so that it must be replaced. Thus there exists a need for a device that allows emergency personnel to quickly access a doorway with a pin tumbler lock without damaging the lock.

### BRIEF SUMMARY OF INVENTION

The invention is a device for opening a pin tumbler type of lock, wherein the pin tumbler type of lock has a number of driver pins and a number of key pins, each of the key pins aligned with one of the driver pins. The device has a housing with a key end and a spring end. A spring inside the housing is located at the spring end of the housing. A slide has a first end fitting inside the housing and abutting an end of the spring. A trigger mechanism is attached to the housing and engages the slide. A key holder is attached to a second end of the slide. A bottom cut key is inserted into the key holder.

To use the device, the device is cocked and the key is inserted all the way into the lock. The key is then pulled back one notch and a slight rotational pressure is applied. The user then pulls the trigger and then rotates the key to open the lock. This device allows emergency personnel to quickly access a doorway with a pin tumbler lock without damaging the lock.

### BRIEF DESCRIPTION OF THE SEVERAL VIEWS OF THE DRAWINGS

FIG. 1 is a cutaway view of a pin tumbler type of lock in accordance with one embodiment of this invention; and

FIG. 2 is a cutaway view of a device for opening a pin tumbler type of lock in accordance with one embodiment of the invention.

### DETAILED DESCRIPTION OF THE INVENTION

The invention is a device for opening a pin tumbler type of lock, wherein the pin tumbler type of lock has a number of driver pins and a number of key pins, each of the key pins aligned with one of the driver pins. The device has a housing with a key end and a spring end. A spring inside the housing is located at the spring end of the housing. A slide has a first end fitting inside the housing and abutting an end of the spring. A trigger mechanism is attached to the housing and engages the slide. A key holder is attached to a second end of the slide. A bottom cut key is inserted into the key holder.

To use the device, the device is cocked and the key is inserted all the way into the lock. The key is then pulled back one notch and a slight rotational pressure is applied. The user then pulls the trigger and then rotates the key to open the lock. This device allows emergency personnel to quickly access a doorway with a pin tumbler lock without damaging the lock. The action of the slider moving forward causes the teeth in the key to push against the key pins and in turn the driver pins. This causes all the driver pins to be above the shear point and all the key pins to be below the shear point allowing the lock to be opened.

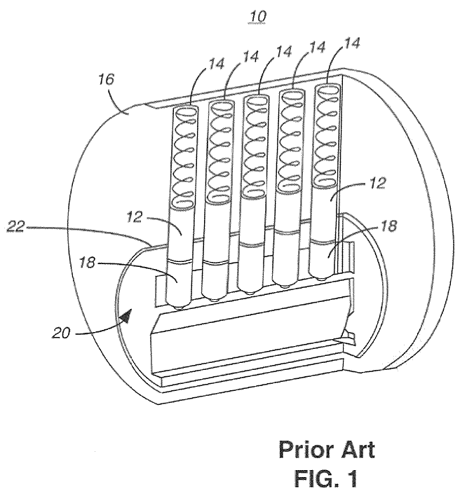

FIG. 1 is a cutaway view of a pin tumbler type of lock 10 in accordance with one embodiment of this invention. A pin tumbler lock 10 will be explained so that the invention may be better understood. The lock 10 has upper or driver pins 12 (five are shown in the drawing) abutting springs 14 in the fixed portion 16 of the lock 10. The driver pins 12 abut the lower of key pins 18, which are located in the revolving plug 20. All of these type of locks have unequal lengths the key pins 18 and associated driver pins 12 must be raised in order for all the key pins 18 to be below the shear point 22 and all the driver pins 12 to be above the shear point 22. The shear point 22 is the line where the revolving plug 20 meets the fixed portion 16 of the lock. When the pins are aligned on the shear point the lock may be rotated to lock or unlock the door. These locks are made with various numbers of tumblers (set of upper and lower pins), and with various shapes or cross sections of keys fitting similarly shaped key slots. The present invention works with all these variation, by just selecting the proper bottom cut key.

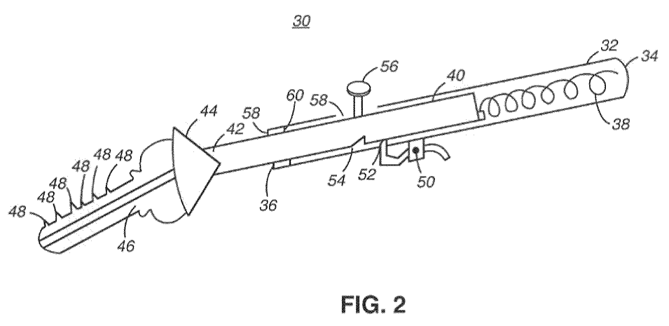

FIG. 2 is a cutaway view of a device 30 for opening a pin tumbler type of lock in accordance with one embodiment of the invention. The device 30 has a housing 32, which may be cylindrical. The housing 32 has a spring end 34 and a key or open end 36. A spring 38 fits in the housing 32 at the spring end 34. One end of the spring 38 abuts one end of a slider 40. The other end 42 of the slider 40 is attached to a key holder 44. The key holder 44 may be a V shaped appendage with a slot to hold an end of the key. A bottom cut key 46 engages the key holder 44. A bottom cut key 46 is a key with the teeth 48 at their lowest levels. A trigger mechanism 50 is attached to the housing 32. The trigger mechanism 50 has a trigger pin 52 that engages a trigger notch 54 in the slide 40 when the device 30 is cocked. A charging handle 56 is attached to the slide 40 and protrudes through an opening 58 in the housing 32. The charging handle is used to move the slide 40 from the released position to a cocked position.

Note that the spring 38 may be replaced with any energy imparting mechanism, such as a CO2 cartridge. So long as the slide is moved from a first or cocked position to a second or released position. A pair of flanges 58, 60 on the housing 32 and the slider 40 prevent the slider from completely exiting the housing 32 in one embodiment.

A number of different bottom cut keys may be necessary for different manufacturers or types of locks.

To use the device, the device is cocked and the key is inserted all the way into the lock. The key is then pulled back one notch and a slight rotational pressure is applied. The user then pulls the trigger and then rotates the key to open the lock. This device allows emergency personnel to quickly access a doorway with a pin tumbler lock without damaging the lock. The action of the slider moving forward causes the teeth in the key to push against the key pins and in turn the driver pins. This causes all the driver pins to be above the shear point and all the key pins to be below the shear point allowing the lock to be opened.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A device for opening a pin tumbler type of lock, wherein the pin tumbler type of lock has a plurality of driver pins and a plurality of key pins, each of the plurality of key pins aligned with one of the plurality of driver pins, comprising:
a housing having a key end and a spring end;
a spring inside the housing located at the spring end of the housing;
a slide having a first end fitting inside the housing and abutting an end of the spring;
a trigger mechanism attached to the housing and engaging the slide; and
a key holder attached to a second end of the slide.

2. The device for opening the pin tumbler type of lock of claim 1, further including a bottom cut key engaging the key holder.

3. The device for opening the pin tumbler type of lock of claim 1, further including a charging handle attached to the slide and extending through an opening in the housing.

4. The device for opening the pin tumbler type of lock of claim 3, wherein the slide has a trigger notch that engages a trigger pin.

5. The device for opening the pin tumbler type of lock of claim 4, wherein the key holder is a V-shaped pocket.

6. The device for opening the pin tumbler type of lock of claim 1, wherein the slide has a cocked position and a released position.

7. A device for opening a pin tumbler type of lock, wherein the pin tumbler type of lock has a plurality of driver pins and a plurality of key pins, each of the plurality of key pins aligned with one of the plurality of driver pins, comprising:
a housing having a closed end and an open end;
a slide fitting into the open end of the housing;
an energy imparting mechanism moving the slide from a first position to a second position; and
a trigger mechanism causing the energy imparting mechanism to move the slide for the first position to the second position.

8. The device for opening a pin tumbler type of lock of claim 7, further including a key holder attached to an end of the slide.

9. The device for opening a pin tumbler type of lock of claim 8, further including a bottom cut key engaging the key holder.

10. The device for opening a pin tumbler type of lock of claim 9, wherein the energy imparting mechanism is a spring.

11. A method of opening a pin tumbler type of lock, wherein the pin tumbler type of lock has a plurality of driver pins and a plurality of key pins, each of the plurality of key pins aligned with one of the plurality of driver pins, and a plurality of springs aligned with the plurality of driver pins, comprising the steps of:
installing a proper bottom cut key into a device for opening a pin tumbler type of lock;
placing the proper bottom cut key into a lock;
pulling the proper bottom cut key one position;
applying a rotational pressure to the device; and
pulling a trigger on the device.

12. The method of opening a pin tumbler type of lock of claim 11, wherein the step of installing the proper bottom cut key, includes the step of determining a lock keyway type.

13. The method of opening a pin tumbler type of lock of claim 11, wherein the step of installing the proper bottom cut key includes the step of pulling a charging handle to cock the device.

14. The method of opening a pin tumbler type of lock of claim 11, further including the step of rotating the proper bottom cut key to open the lock.
